(19) United States
(12) Patent Application Publication
(10) Pub. No.: US 2012/0138709 A1
(43) Pub. Date: Jun. 7, 2012

(54) DISK SPRAY DEVICE

(75) Inventors: Mikhail ANKIRSKY, Taichung County (TW); Chiu-Hsiang Lin, Taichung County (TW)

(73) Assignee: OAV EQUIPMENT & TOOLS, INC., Taichung Hsien (KR)

(21) Appl. No.: 12/959,514

(22) Filed: Dec. 3, 2010

(51) Int. Cl. B05B 7/00

(52) U.S. Cl. 239/418

(57) ABSTRACT

A disk spray device includes a shell having a bottom air inlet and a lateral air outlet, a fan rotatably mounted in the shell for streaming air through the bottom air inlet into the shell and then out of the lateral air outlet, and a spray tube mounted around an outer periphery of the shell and having a plurality of nozzles near the lateral air outlet of the shell. The spray tube is adapted to be connected with a water supply device such that water running in the spray tube can be sprayed into water mist through the nozzles of the spray tube. The water mist can be further delivered far way by the wind that is exhausted out of the lateral air outlet of the shell by the fan.

### BACKGROUND OF THE INVENTION

1. Field of the Invention

The present invention relates generally to a spray device, and more specifically to a disk spray device utilizing a fan to broaden a spray range of water mist.

2. Description of the Related Art

Under a dry or hot environment, a spray device set at a predetermined height may be used to spray water mist downwards to increase the air humidity or lower the temperature. A conventional spray device generally includes a water pipe and a plurality of nozzles connected with the water pipe for discharging water in the form of water mist. Since the water mist is usually sprayed inclinedly and downwardly through the nozzles, the spraying range of the water mist is limited to a small extent around the nozzles. If the water mist needs to cover a wide area, the number of the nozzles must be relatively increased. Furthermore, if the conventional spray device is set in a dry and cold environment, people standing below the conventional spray device may feel colder because the water mist is sprayed in a narrow range to accumulatedly fall on them. Thus, it is desirable to provide a spray device that can eliminate the aforesaid drawbacks.

### SUMMARY OF THE INVENTION

It is one objective of the present invention to provide a disk spray device, which has a wide spraying range of water mist.

To achieve this objective of the present invention, the disk spray device provided by the present invention comprises a shell having a bottom air inlet and a lateral air outlet, a fan rotatably mounted in the shell, and a spray tube mounted around an outer periphery of the shell and having a plurality of nozzles near the air outlet of the shell. By this way, when the spray tube is connected with a water supply device, water running in the spray tube can be sprayed through the nozzles into water mist. The water mist can be further delivered far way to cover a wide range by the wind that is exhausted out of the lateral air outlet of the shell by the fan.

Further scope of applicability of the present invention will become apparent from the detailed description given hereinafter. However, it should be understood that the detailed description and specific examples, while indicating preferred embodiments of the invention, arc given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a disk spray device according to a preferred embodiment of the prevent invention;

FIG. 2 is an exploded view of the disk spray device according to the preferred embodiment of the prevent invention;

FIG. 3 is another exploded view of the disk spray device according to the preferred embodiment of the prevent invention; and

FIG. 4 is a lateral view of the disk spray device according to the preferred embodiment of the prevent invention.

### DETAILED DESCRIPTION OF THE INVENTION

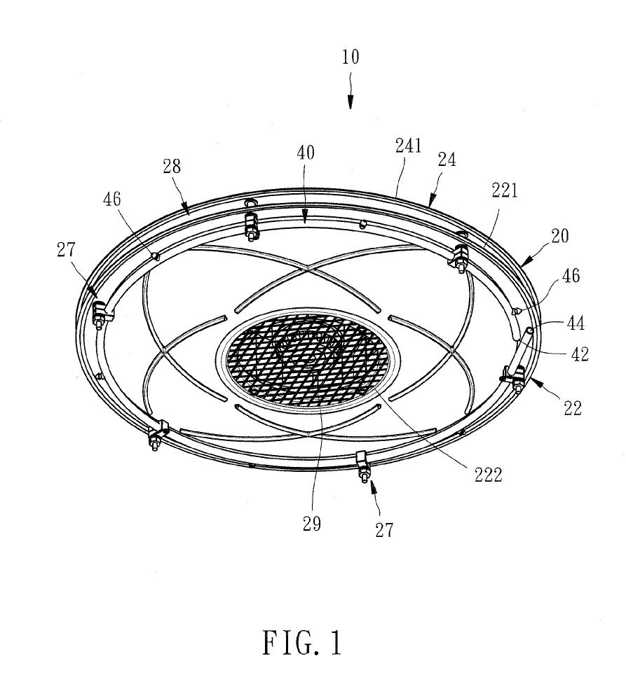

As shown in FIGS. 1 to 3, a disk spray device 10 in accordance with a preferred embodiment of the present invention comprises a shell 20, a fan 30, and a spray tube 40.

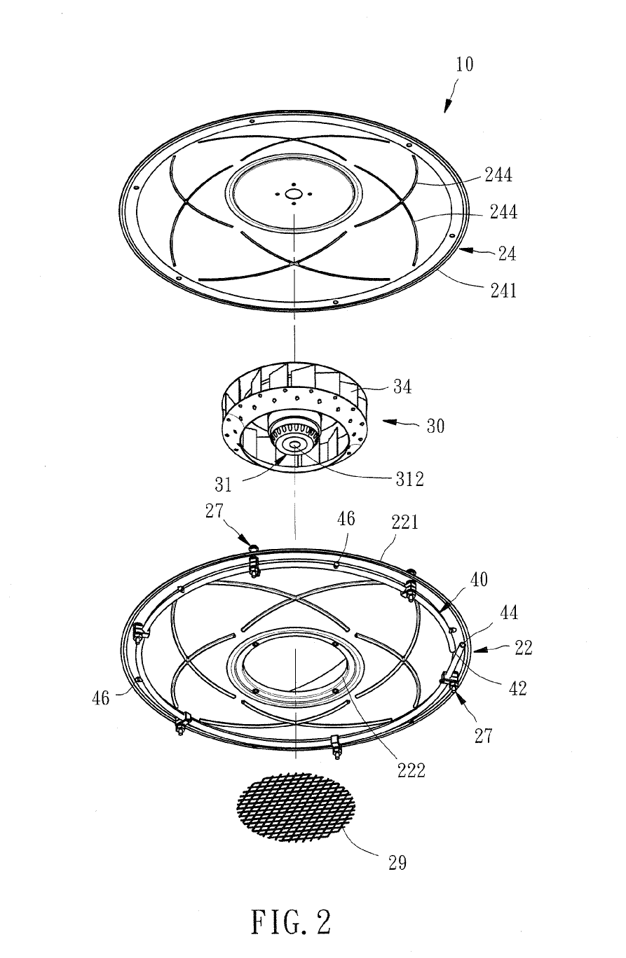

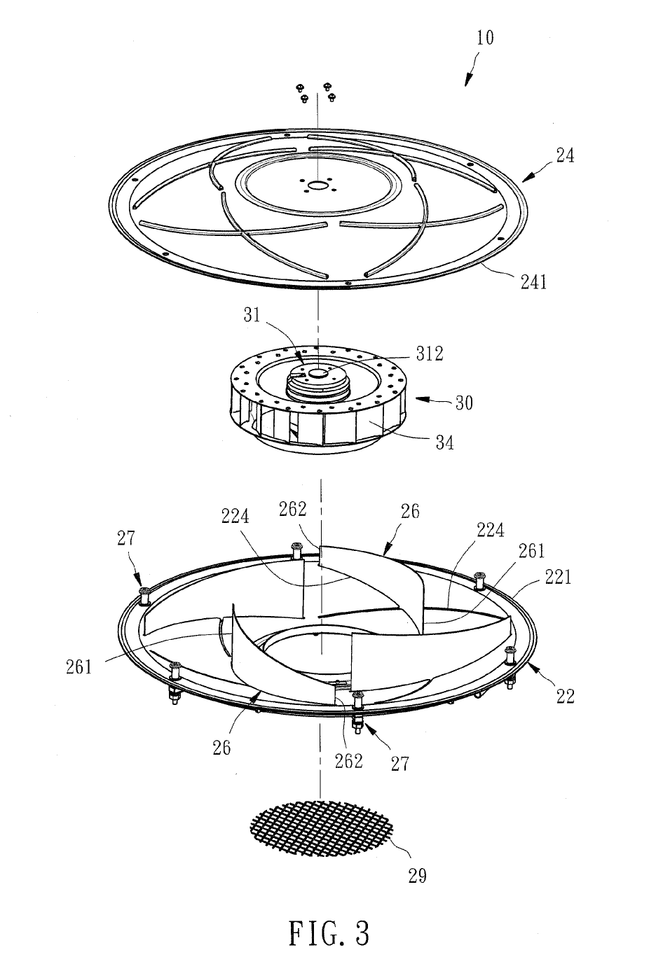

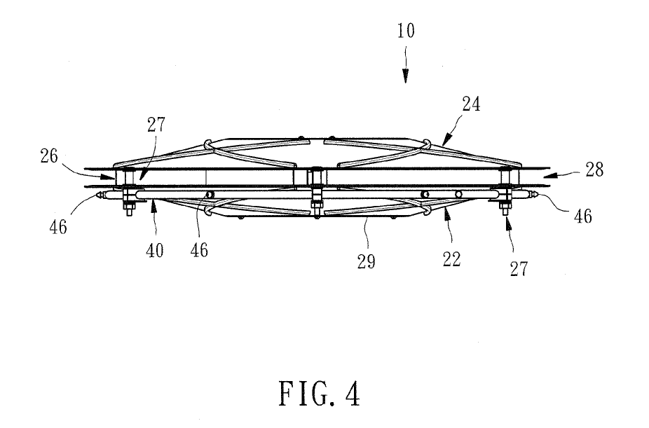

The shell 20 includes a lower shell body 22, an upper shell body 24, and four guide plates 26. The upper shell body 24 and the lower shell body 22 are similar in configuration. The lower shell body 22 has a top opening 221 at a top thereof, a bottom air inlet 222 at a bottom thereof, and four pairs of smoothly curved locating grooves 224 at an inner side thereof, as shown in FIG. 3. The two locating grooves 224 of each pair are intersected with each other, and respectively curvedly extend from locations adjacent to the air inlet 222 in clockwise and counterclockwise directions. The upper shell body 24 has a bottom opening 241 at a bottom thereof. The upper shell body 24 is fastened to the lower shell body 22 by a plurality of fasteners 27 in such a way that the opening 241 of the upper shell body 24 and the opening 221 of the lower shell body 22 are face-to-face with and spaced a distance from each other to form an annular lateral air outlet 28 around a lateral side of the shell 20, as shown FIG. 4. Further, the upper shell body 24 is provided at an inner side there of a plurality of locating grooves 244 corresponding in location and configuration to the locating grooves 224 of the lower shell body 22, as shown in FIG. 2. The guide plates 26 are mounted between the upper shell body 24 and the lower shell body 22 in such a way that the guide plates 26 arc respectively inserted into four of the locating grooves 244 of the upper shell body 24 and corresponding four of the locating grooves 224 of the lower shell body 22, such that the guide plates 26 each extend curvedly from a first lateral side 261 thereof adjacent to the air inlet 222 to a second lateral side 262 thereof adjacent to the air outlet 28.

The fan 30 is mounted in the shell 20, and has a motor 31 with a rotating shaft 312 extending along a direction perpendicular to the air inlet 222, and a plurality of blades 34 arranged around and parallel to the rotating shaft 312. Besides, external objects can be stopped from getting into the shell 20 to damage the fan 30 by a screen guard 29 installed in the air inlet 222 of the shell 20.

The spray tube 40 is mounted around an outer periphery of the lower shell body 22 in such a way that the spray tube 40 passes through the fasteners 27 and is located adjacent to the opening 221. The spray tube 40 is provided with a closed end 42, an open end 44, and a plurality of nozzles 46 adjacent to the air outlet 28 of the shell 20 for spraying water mist horizontally.

When the disk spray device 10 of the present invention is used, a water supply device (not shown) is connected with the open end 44 of the spray tube 40 such that water running in the spray tube 40 can be sprayed in the form of water mist through the nozzles 46 of the spray tube 40, and meanwhile the air is sucked by the fan 30 through the air inlet 222 into the shell 20, and streamed by the rotation of the blades 34. The wind streamed by the fan 30 can be guided by the guide plates 26 toward the air outlet 28 of the shell 20, and exhausted horizontally and rotatably out of the shell 20 through the air outlet 28 of the shell 20. As a result, the water mist can be delivered far away from the nozzles 46 of the spray tube 40 toward different directions by the fan 30. Therefore, the disk spray device 10 of the present invention can attain the purpose of broadening a spraying range of water mist.

To deserve to be mentioned, the guide plates 26 are curved in a counterclockwise direction from the air inlet 222 to the air outlet 28 so as to allow the air to be exhausted through the air outlet 28 in a counterclockwise direction. However, the guide plates 26 can be inserted into the clockwise locating grooves 224 and 244 to allow the air to be exhausted in a clockwise direction.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A disk spray device comprising:
a shell having a bottom air inlet and a lateral air outlet;
a fan rotatably mounted in the shell; and
a spray tube mounted around an outer periphery of the shell and having a plurality of nozzles near the air outlet of the shell.

2. The disk spray device as claimed in claim 1, wherein the shell includes an upper shell body having a bottom opening, and a lower shell body having a top opening; the bottom opening of the upper shell body and the top opening of the lower shell body are spacedly face-to-face to form the lateral air outlet around a lateral side of the shell.

3. The disk spray device as claimed in claim 2, wherein the lower shell body of the shell has the bottom air inlet.

4. The disk spray device as claimed in claim 2, wherein the spray tube is located near the top opening of the lower shell body.

5. The disk spray device as claimed in claim 2, wherein a plurality of guide plates arc mounted between the upper shell body and the lower shell body.

6. The disk spray device as claimed in claim 5, wherein the guide plates each have a first lateral side near the bottom air inlet and a second lateral side near the lateral air outlet; each of said guide plates extends curvedly from the first lateral side thereof to the second lateral side thereof.

7. The disk spray device as claimed in claim 5, wherein the upper shell body and the lower shell body both have a plurality of locating grooves for insertion of the guide plates.

8. The disk spray device as claimed in claim 1, wherein the fan has a rotating shaft aimed at the bottom air inlet of the shell, and a plurality of blades parallel to the rotating shaft for streaming air from the bottom air inlet to the lateral air outlet of the shell.

9. The disk spray device as claimed in claim 1, comprising a screen guard installed in the bottom air inlet of the shell.

10. The disk spray device as claimed in claim 1, wherein the nozzles of the spray tube are arranged to spray water substantially horizontally.
